(19) United States
(12) Patent Application Publication
(10) Pub. No.: US 2004/0023116 A1
(43) Pub. Date: Feb. 5, 2004

(54) Non-aqueous electrolyte secondary battery

(76) Inventors: Takemasa Fujino, Gunma (JP); Hiroaki Tanizaki, Miyagi (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/447,794

(22) Filed: May 29, 2003

(30) Foreign Application Priority Data
May 29, 2002 (JP) JP2002-156271

(51) Int. Cl. H01M 4/58

(52) U.S. Cl. 429/231.95; 429/231.4

(57) ABSTRACT

A non-aqueous electrolyte secondary battery having a large discharge capacity and improved charge/discharge cycle characteristics is disclosed. The battery has a negative electrode which comprises a negative electrode active material composed of an element or a compound of the element capable of reacting with lithium, and a negative electrode current collector, where the negative electrode active material contains at least carbon black.

### CROSS REFERENCES TO RELATED APPLICATIONS

The present document is based on Japanese Priority Document JP 2002-156271, filed in the Japanese Patent Office on May 29, 2002, the entire contents of which being incorporated herein by reference.

### BACKGROUND OF THE INVENTION

1. Field of the Invention

The present invention relates to a non-aqueous electrolyte secondary battery using, as a negative electrode active material thereof, an element or a compound of the element capable of reacting with lithium.

2. Description of the Related Art

Secondary batteries are widely used as portable power sources for a camera-integrated video tape recorder, a laptop computer, and various mobile electronic appliances or communication tools. In particular, a lithium ion secondary battery has an energy density larger than that of conventional aqueous electrolyte secondary batteries such as a lead battery, a nickel-cadmium batteries and the like, and activities for improving the characteristics are still on the way. The lithium ion secondary battery uses, for a negative electrode active material thereof, a carbonaceous material such as a non-graphitizable carbon, a graphite or the like in order to obtain a relatively large capacity and excellent cycle characteristics.

As for the lithium ion secondary battery, various efforts have been directed to further raise the capacity through selection of novel materials in place of the carbonaceous materials, or through improvement in manufacturing steps. For example, Japanese Patent Application Publication Laid-Open No. Hei 8-315825 proposes a technology for raising capacity of a battery having a negative electrode composed of a carbonaceous material by proper selection of source materials for carbonization and manufacturing conditions. The negative electrode composed of the carbonaceous material, however, has a negative electrode discharge potential over lithium of only as low as 0.8 V to 1.0 V, so that a battery configured using this negative electrode can give only a low discharge voltage, and improvement in energy density of the battery cannot be much expectable. The negative electrode composed of the carbonaceous material is also disadvantageous in that the charge-discharge cycle curve thereof shows a large hysteresis, which means a low energy efficiency in the individual charge-discharge cycles, and is intrinsically not ideal for the negative electrode.

Another investigation on the lithium ion secondary battery relates to use of a certain kind of a lithium alloy such as Li—Al, which is known to show electrochemically reversible generation/decomposition characteristics, as a large-capacity negative electrode member alternative to the carbonaceous material. For example, U.S. Pat. No. 4,950,566 discloses a large-capacity negative electrode member based on a Li—Si alloy. The lithium-alloy negative electrode member, however, suffers from a problem that it considerably expands or shrinks during the charge/discharge cycle and thus may cause cracks or separation, and repetitive charge/discharge cycles may even pulverize the lithium alloy to thereby ruin the cycle characteristics.

Investigations have therefore been made on the negative electrode member capable of improving the cycle characteristics in which the lithium alloy is added with an element not involved in the expansion-and-shrinkage in response to insertion/extraction of lithium to thereby improve the cycle characteristics. For example, Japanese Patent Application Publication Laid-Open No. Hei 6-325765 discloses a negative electrode member composed of a lithium alloy, composition of which is expressed as LiₓSiO_{y} (x≧0, 2>y>0). Japanese Patent Application Publication Laid-Open No. Hei 7-230800 discloses a negative electrode member composed of a lithium alloy, composition of which is expressed as LiₓSi_{1-y}M_{y}O_{z} (x≧0, 1>y>0, 2>z>0). Japanese Patent Application Publication Laid-Open No. Hei 7-288130 discloses a negative electrode member composed of a Li—Ag—Te alloy. Japanese Patent Application Publication Laid-Open No. Hei 11-102705 discloses a large-capacity negative electrode member composed of a compound which includes a Group 4B element other than carbon and at least one non-metallic element.

It is, however, still difficult for the lithium ion secondary battery to fully suppress the cracks, separation and pulverization of the negative electrode active material under repetitive charge/discharge cycles even when the aforementioned lithium alloys are used as the negative electrode member, and this undesirably promotes degradation of charge/discharge cycle characteristics. That is, there has been a problem that the lithium ion secondary battery could not fully exhibit the characteristics thereof even if the novel large-capacity negative electrode member is used.

### SUMMARY OF THE INVENTION

The present invention is therefore to provide a non-aqueous electrolyte secondary battery capable of improving charge/discharge cycle characteristics as well as having a larger capacity.

The non-aqueous electrolyte secondary battery for accomplishing the aforementioned object according to one aspect of the present invention comprises a negative electrode comprising a negative electrode active material composed of an element or a compound of the element capable of reacting with lithium, and a negative electrode current collector; a positive electrode comprising a positive electrode active material and a positive electrode current collector; a non-aqueous electrolyte; and a container for enclosing the negative electrode, the positive electrode and the non-aqueous electrolyte; where the negative electrode active material of the negative electrode contains carbon black.

The non-aqueous electrolyte secondary battery for accomplishing the aforementioned object according to another aspect of the present invention comprises a negative electrode comprising a negative electrode active material composed of an element or a compound of the element capable of reacting with lithium, and a negative electrode current collector; a positive electrode comprising a positive electrode active material and a positive electrode current collector; a non-aqueous electrolyte; and a container for enclosing the negative electrode, the positive electrode and the non-aqueous electrolyte; where the negative electrode active material of the negative electrode contains carbon black and fibrous graphite.

According to still another aspect of the present invention, the non-aqueous electrolyte secondary battery uses the carbon black having a DBP oil absorption of 150 ml/100 g to 250 ml/100 g, and a specific surface area of 50 m²/g to 150 m²/g. The non-aqueous electrolyte secondary battery has the negative electrode active material comprising a Group 4B compound comprising a Group 4B element other than carbon and at least one nonmetallic element.

In thus-configured, non-aqueous electrolyte secondary battery, the carbon black added to the negative electrode active material intervenes in a network of material grains by forming a certain kind of structure and thus improves electric conductivity of the negative electrode, and functions as a cushion material so as to improve flexibility and anti-cracking property under bending. Therefore the non-aqueous electrolyte secondary battery is successful in suppressing pulverization of the negative electrode active material due to expansion-and-shrinkage in response to charge/discharge, in increasing the initial charge/discharge efficiency (Coulomb efficiency), in raising capacity, and in upgrading the charge/discharge cycle characteristics.

In thus-configured, non-aqueous electrolyte secondary battery, fibrous graphite added together with the carbon black to the negative electrode active material improves binding property of the network structure of the material grains to thereby reduce generation of cracks or separation due to expansion-and-shrinkage in response to charge/discharge, and to thereby suppress the pulverization. Therefore the non-aqueous electrolyte secondary battery is successful in increasing the initial charge/discharge efficiency (Coulomb efficiency), in raising capacity, and in further upgrading the charge/discharge cycle characteristics.

### BRIEF DESCRIPTION OF THE DRAWINGS

The above and other objects, features and advantages of the present invention will become more apparent from the following description of the presently preferred exemplary embodiment of the invention taken in conjunction with the accompanying drawings, in which:

FIG. 1 is a graph showing characteristics of discharge capacity retention ratio plotted against DBP oil absorption of lithium ion secondary batteries obtained in Examples and Comparative Examples; and

FIG. 2 is a graph showing characteristics of efficiency plotted against specific surface area of lithium ion secondary batteries obtained in Examples and Comparative Examples.

### DESCRIPTION OF THE PREFERRED EMBODIMENTS

The following paragraphs will describe the present invention in detail. The non-aqueous electrolyte secondary battery comprises a large-capacity negative electrode comprising a negative electrode active material composed of an element or a compound of the element capable of reacting with lithium, and a negative electrode current collector; a positive electrode comprising a positive electrode active material and a positive electrode current collector; a non-aqueous electrolyte; and a container for enclosing the negative electrode, the positive electrode and the non-aqueous electrolyte. Although the non-aqueous electrolyte secondary battery will not be illustrated herein, a negative electrode terminal and a positive electrode terminal are attached to the container, and through these terminals extraction of power output and charging are available.

For the negative electrode member, a metal or an alloyed compound of the metal capable of alloying with lithium is available as the negative electrode active material therefor. Assuming now that a metal element capable of alloying with lithium is expressed by M1, examples of the metal element M1 include Mg, B, Al, Ga, In, Si, Ge, Sn, Pb, Sb, Bi, Cd, Ag, Zn, Hf, Zr and Y. Among these metal elements M1, Group 4B typical elements such as Si and Sn are preferably used for the negative electrode active material, and Sn is more preferable. It should be noted that in the context of this specification, semiconductor elements such as B, Si, As capable of alloying with lithium are also included in the metal elements.

For the negative electrode active material, alloyed compounds of the metal element M1 expressed by a chemical formula of M1ₓM2_{y}Li_{z} (where, M2 is one or more metal elements other than Li and M1, x is an integer larger than 0, and y and z are integers equals to or larger than 0) are available. Examples of the alloyed compound available for the negative electrode active material include Li—Al, Li—Al-M3 (where, M3 is any one metal element selected from Group 2A, 3B and 4B transition metal elements), or alloyed compounds of the metal element M1 such as AlSb and CuMgSb.

For the negative electrode active material, alloyed compounds of Si and Sn, both of which are Group 4B elements, expressed by a chemical formula of M4ₓSi or M4ₓSn (where, M4 is one or more metal elements other than Si and Sn) are available. Examples of the alloyed compound available for the negative/electrode active material include CuSn, SiB₄, SiB₆, Mg₂Si, Mg₂Sn, Ni₂Si, TiSi₂, MoSi₂, CoSi₂, NiSi₂, CaSi₂, CrSi₂, CU₅Si, FeSi₂, MnSi₂, NbSi₂, TaSi₂, VSi₂, WSi₂ and ZnSi₂.

For the negative electrode active material, compounds of a Group 4B element other than carbon containing at least one or more non-metallic element are available. The negative electrode active material may be a compound containing one or more Group 4B elements, or may be a compound containing lithium and a metal element other than Group 4B element. Examples of the compounds include SiOₓ (0<x≦2), SnOₓ (0<x≦2), Si₃N₄, Si₂N₂O, Ge₂N₂O, LiSiO and LiSnO. The above-descried materials may be used for the negative electrode active material independently or in combination of two or more of them.

In preparation of the negative electrode, insertion of lithium into the negative electrode active material may be carried out after a battery is manufactured and within the battery, or may be carried out electrochemically before or after manufacture of the battery as being supplied from a positive electrode or from a lithium source other than the positive electrode. In preparation of the negative electrode, insertion of the lithium into the negative electrode active material may also be accomplished through material synthesis by which the negative electrode active material is obtained as a lithium-containing material. The negative electrode member can be processed into the negative electrode typically by a mechanical alloying method; atomizing methods such as a liquid atomizing method and a gas atomizing method; roll rapid cooling methods such as a single roll method and a double roll method; and a rotary electrode method.

In the negative electrode, the above-described, high-capacity negative electrode active material naturally tends to pulverize due to large expansion and shrinkage during charge and discharge. The negative electrode active material of the negative electrode is thus added with carbon black, that is, an amorphous carbon which allows insertion/extraction of lithium thereto and therefrom, shows a nearly concentric spherical orientation between grains of the negative electrode active material, functions as a conductive material capable of raising conductivity by forming a certain structure, and is used as an additive intended for raising reinforcement property, anti-friction property, and anti-cracking property under bending. Because the added carbon black intervenes in a network of the grains of the negative electrode active material by forming a certain kind of structure and functions as a cushion material so as to improve the flexibility, the negative electrode active material is prevented from causing pulverization due to expansion and shrinkage during charge and discharge, and this is successful in improving the charge/discharge cycle characteristics.

While there is no special limitation on species of the carbon black, available examples thereof include acetylene black, Ketjen black, thermal black and furnace black, which are prepared by any of a thermal method, an acetylene decomposition method, a contact method, a lamp-black method, a gas furnace method and an oil furnace method. Among others, the acetylene black obtained by the acetylene decomposition method is preferably used.

The carbon black available herein is such as showing a DBP oil absorption value of 150 ml/100 g to 250 ml/100 g when measured using a DBP (dibutylphthalate) absometer specified by ASTM D2414 and JIS K6221 A method. The carbon black available herein is also such as showing a specific surface area for nitrogen absorption per unit weight of 50 m²/g to 150 m²/g when measured according to ASTM D3037-84 B method.

The carbon black having a DBP oil absorption less than 150 ml/100 g has only a poorly-developed structure, cannot exhibit a cushion effect sufficient enough to suppress separation or cracks between grains of the negative electrode active material due to expansion and shrinkage during the charge and discharge, and may result in pulverization. It is thus difficult for this kind of carbon black to fully improve the relative discharge capacity of the battery. On the contrary, the carbon black having a DBP oil absorption exceeding 250 ml/100 g has a well-developed structure and thus well suppresses the pulverization, but shows only a small dispersibility in the negative electrode active material. Although this kind of carbon black per se has a large conductivity, its poor dispersibility in the negative electrode active material degrades conductivity of the negative electrode member, and consequently degrades the battery characteristics.

The negative electrode member may also be added with various carbonaceous materials besides the carbon black having the above-described characteristics. Available carbonaceous materials include non-graphitizable carbon, graphites including artificial graphite and naturally-occurred graphite, pyrolytic carbons, various cokes (pitch coke, needle coke, petroleum coke, etc.), vitreous carbon (glass-like carbon), sintered organic polymer compounds (carbonized phenol resin or furan resin obtained after sintering it at an appropriate temperature), activated carbon, and fibrous graphite. The negative electrode active material may also be added with various materials hot affective to the charge/discharge characteristics.

The fibrous graphite improves binding property of the network structure of the grains of the negative electrode active material, to thereby suppress pulverization thereof due to expansion and shrinkage during charge and discharge. The fibrous graphite can be produced by graphitizing the fibrous carbon. Available fibrous carbons include those obtained by annealing precursors composed of fiber-formed polymer or pitch, or vapor-phase-grown carbon obtained by directly supplying organic compound vapor such as benzene over a substrate heated to 1,000° C. or around, and by using an iron particle as a catalyst so as to grow carbon crystals. Available precursors include polyacrylonitrile (PAN), rayon, polyamide, lignin and polyvinyl alcohol.

Available pitches include coal tar, ethylene bottom oil, various tars obtained by high temperature pyrolysis of crude oil or the like; pitches obtained by subjecting asphalt to various distillations (vacuum distillation, normal pressure distillation or steam distillation), thermal condensation polymerization, extraction, chemical condensation polymerization; and pitches obtained by dry distillation of lumber. Starting materials of the pitch may typically be any of poly-vinyl chloride resin, polyvinyl acetate, poly-vinyl butylate and 3,5-dimethylphenol resin. Coal and pitch exist in a form of liquid in an atmosphere maximum at 400° C. during carbonization, and keeping of this temperature allows aromatic rings of these materials to condense to thereby produce polycyclic compounds and to thereby form a stacked orientation. Then raising of the temperature to approximately as high as 500° C. or above results in production of solid-state carbon precursor, or semi-cokes. This production process is known as liquid-phase carbonization, and is a typical production process for graphitizable carbon.

Other possible starting materials for the fibrous carbon include condensed polycyclic hydrocarbon compounds such as naphthalene, phenanthlene, anthracene, triphenylene, pyrene, perylene, pentaphene and pentacene; derivatives of these compounds such as carboxylic acid derivatives, carboxylic anhydride derivatives and carboxylic imide derivatives; and mixtures of these compounds. Possible starting materials for the fibrous graphite include condensed heterocyclic compounds such as acenaphthylene, indole, isoindole, quinoline, isoquinoline, quinoxaline, phthalazine, carbazole, acridine, phenazine, and phenanthridine; and derivatives of these compounds.

The aforementioned polymer-based precursor and pitch-based precursor are subjected to curing process or stabilizing process, and are further annealed under high temperatures so as to produce the fibrous carbon. The curing process or stabilizing process herein refers to a process by which a surface of the fiber is oxidized using an acid, oxygen or ozone so as to prevent the polymer or the like from melting or being decomposed by heat during the carbonization, and is properly designed depending on the species of the precursor and, if necessary, is repeated a plural number of times so as to ensure thorough stabilization. It should be noted now that the temperature of the curing process or stabilizing process must be set lower than the melting point of the precursor.

The aforementioned polymer-based precursor is subjected to the curing process or stabilizing process, then carbonized under heating at 300° C. to 700° C. in an inert gas atmosphere such as nitrogen atmosphere, and further calcined in an inert gas atmosphere at a temperature elevation speed of 1° C. to 100° C./min, an ultimate temperature of 900° C. to 1,500° C., and a retention time at the ultimate temperature of 0 hour to 30 hours or around, to thereby produce the fibrous carbon. The polymer-based precursor or pitch-base precursor may be used without being undergone through the carbonization process if the situation permits.

The fibrous carbon produced by the vapor phase growth process can be obtained using vaporizable organic compounds as the starting materials thereof. The starting materials include gaseous substance at the normal temperature such as ethylene and propane, and organic compounds vaporizable under heating at temperatures lower than pyrolysis temperatures thereof. The starting materials supplied in a gaseous form directly onto a substrate causes crystal growth to thereby produce the fibrous carbon. Temperature of the vapor phase growth is preferably selected within a range from 400° C. to 1,500° C., where proper selection thereof is allowable depending on species of the starting materials. Bases preferably available in the vapor phase growth include those composed of quartz, nickel or the like, and can properly be selected as being suited to the starting materials.

In the vapor phase growth, catalysts properly selected as being suited to the starting materials are used in order to promote the crystal growth. Examples of the catalyst include pulverized iron, nickel, or mixtures thereof, and also include various metals and metal oxides known as so-called graphitization catalysts.

The fibrous carbon can be produced so as to have appropriate outer diameter or length by adjusting production conditions. For a case where any polymer is used as the starting material, a diameter or length of the fibrous carbon can be adjusted by properly setting an inner diameter and an ejection speed of an ejection nozzle for fiber formation. For a case where the vapor phase growth method is adopted, the diameter of the fibrous carbon can appropriately be adjusted by properly setting a size of portions of a base, catalyst or the like which can serve as a seed for the crystal growth. The diameter or linearity of the fibrous carbon can appropriately be adjusted also by properly determining the amount of supply of the organic compounds, or the starting materials, such as ethylene, propane and the like.

The fibrous carbon produced according to the aforementioned methods is further processed so as to obtain fibrous graphite in an inert gas atmosphere, at a temperature elevation speed of 1° C./min to 100° C./min, an ultimate temperature of 2,000° C. or above and more preferably 2,500° C. or above, and a retention time at the ultimate temperature of 0 hour to 30 hours or around. The fibrous carbon may be used after being ground so as to have an appropriate grain size depending on the thickness of the negative electrode or grain size of the negative electrode active material, and may be used also in a single fiber form. The grinding of the fibrous carbon is carried out before or after the carbonization or calcination, or during the process of temperature elevation before the graphitization.

The negative electrode member is configured so that the aforementioned negative electrode active material is coated on a negative electrode current collector, although a specific form thereof may differ depending on battery types. The negative electrode member is formed by first preparing a slurry in which the negative electrode active material and polyvinylidene fluoride (PVdF) as a binder are mixed and added with n-methylpyrolidone (NMP) as a solvent, uniformly coating the slurry on a main surface of the negative electrode current collector typically by the doctor-blade method, dried at high temperatures so as to vaporize NMP, and compressed using a roll press machine so as to raise the density. The negative electrode current collector of the negative electrode member is typically composed of a copper foil.

The positive electrode member comprises a positive electrode active material and a positive electrode current collector, on a main surface of which a positive electrode active material layer is formed. As the positive electrode active material, metal oxides, metal sulfides or special kinds of polymers are available depending on types of the battery. Available examples thereof include lithium-free metal sulfides or metal oxides such as TiS, MoS, NbS and VO; and lithium composite oxides mainly comprising a compound expressed by a chemical formula LiₓM5O (where, M5 represents one or more transition metals, and x generally satisfies 0.05≦x≦1.10 although variable depending on charge/discharge conditions of the battery). Preferable examples of transition metal M5 include Co, Ni and Mn.

Examples of the lithium composite oxide include LiCoO, LiNiO, those expressed by a chemical formula LiₓNi_{y}CoO (where, x and y satisfy 0<x<1 and 0.7<y<1.02, respectively, although variable depending on charge/discharge conditions of the battery), and spinel-type, lithium-manganese composite oxides. These lithium composite oxides can characteristically generate high voltage, and thus can compose the positive electrode active material excellent in the energy density. The positive electrode active material may be composed not only of a single material selected from the above, but also of two or more materials in a mixed form. It is also allowable to mix artificial graphite or carbon black as a conductive material.

The positive electrode member is configured so that the aforementioned positive electrode active material is coated on the positive electrode current collector, although a specific form thereof may differ depending on battery types. The positive electrode member is formed by first preparing a slurry in which the positive electrode active material and polyvinylidene fluoride (PVdF) as a binder are mixed and added with n-methylpyrolidone (NMP) as a solvent, uniformly coating the slurry on the main surface of the positive electrode current collector typically by the doctor-blade method, dried at high temperatures so as to vaporize NMP, and compressed using a roll press machine so as to raise the density. The positive electrode current collector of the positive electrode member is typically composed of an aluminum foil.

The non-aqueous electrolyte is properly selected from an electrolyte-solution prepared by dissolving an electrolyte salt in an non-aqueous solvent, a solid electrolyte containing an electrolyte salt and, a gel electrolyte prepared by impregnating a non-aqueous solvent and an electrolyte salt into an organic polymer, and so forth, depending on a specification of a target battery. The electrolyte salts may be any of those generally used for batteries using non-aqueous electrolyte system, where specific examples of which include LiClO, LiAsF, LiPF, LiBF, LiB(CH), CHSOLi, CFSOLi, LiCl, LiBr and the like.

The non-aqueous electrolyte solution can be prepared by properly combining an organic solvent and an electrolyte salt generally used for batteries using a non-aqueous electrolyte system. Examples of the organic solvent include propylene carbonate, ethylene carbonate, vinylene carbonate, diethyl carbonate, dimethyl carbonate, 1,2-dimethoxyethane, 1,2-diethoxyethane, γ-butyrolactone, tetrahydrofuran, 2-methyltetrahydrofuran, 1,3-dioxolane, 4-methyl-1,3-dioxolane, diethyl ether, sulfolane, methylsulfolane, acetonitrile, propionitrile, anisole, acetic acid ester, lactic acid ester and propionic acid ester.

The solid electrolyte may be either of an inorganic solid electrolyte and a polymer solid electrolyte provided that they have a lithium ion conductivity. Available inorganic solid electrolytes include lithium nitride and lithium iodide. The polymer solid electrolyte comprises a polymer compound containing any of the above-described electrolyte salts, where the polymer compound is used in a form of homopolymer, copolymer or mixture of ether polymers such as poly(ethylene oxide) or cross-linked product thereof, poly(methacrylate) ester polymer, and acrylate polymer.

Matrix for the gel electrolyte may be any species of organic polymers provided they can be gelated after absorbing the non-aqueous electrolyte, and examples thereof include fluorine-containing polymers such as poly(vinylidene fluoride) and poly(vinylidene fluoride-co-hexafluoropropylene); ether polymers such as poly(ethylene oxide) and cross-linked products thereof; and poly(acrylonitrile). In particular for the matrix polymer, it is preferable to use a fluorine-containing polymer which generally has an excellent redox stability. The matrix for the gel electrolyte is given with ion conductivity by containing the electrolyte salt in the non-aqueous electrolyte.

The non-aqueous electrolyte secondary battery is configured by enclosing the aforementioned negative electrode member, positive electrode member and non-aqueous electrolyte in a battery container having a predetermined shape. Small-sized, non-aqueous electrolyte secondary battery typically such as having a coin form or button form can be configured so that a plurality of negative electrode members and a plurality of positive electrode members shaped conforming to the shape of the battery container are stacked, while placing a separator made of a micro-porous polypropylene film in between, and enclosed in the battery container. The non-aqueous electrolyte secondary battery is completed by connecting electrodes to the individual current collectors of the negative electrode and positive electrode members, pouring the non-aqueous electrolyte solution, and sealing the battery container.

The non-aqueous electrolyte secondary battery typically such as having a cylindrical form can be configured so that long-strip-formed negative electrode and positive electrode members are stacked while placing a separator in between, spirally rolled up, and enclosed in a battery container. The non-aqueous electrolyte secondary battery typically such as having a rectangular form can be configured so that a long-strip-formed negative electrode and positive electrode members are stacked while placing a separator in between, folded, and enclosed in a battery container.

### EXAMPLES

The following paragraphs will describe lithium ion secondary batteries as examples of the present invention and comparative examples. Although the lithium ion secondary batteries described herein are configured as coin-type ones, a cylindrical type and other types of batteries can also exhibit similar discriminating features. In the following description, Examples 1-1 to 1-4 and Comparative Examples 1-1 to 1-4 relate to lithium ion secondary batteries having negative electrode active materials containing carbon blacks having characteristics differing from each other, and Examples 2-1 to 2-5 and Comparative Examples 2-1 to 2-4 relate to lithium ion secondary batteries having a negative electrode active material containing both carbon black and fibrous graphite, and having a negative electrode active material in which either of carbon black and fibrous graphite is not contained.

### Example 1-1

Negative electrode: Fifty parts by weight of copper and 50 part by weight of tin are melted, and Cu—Sn powder as the negative electrode active material was synthesized by the gas atomizing method. To 53 parts by weight of the Cu-Sn powder, one part by weight of carbon black having a DBP oil absorption of 150 ml/100 g and a specific surface area of 100 m²/g, 35 parts by weight of artificial graphite, and 10 parts by weight of PVdF as a binder were mixed to thereby prepare a negative electrode mixture, and the negative electrode mixture was further added with NMP (N-methyl-2-pyrolidone) as a solvent to thereby obtain a negative electrode active material in a slurry form. The slurry-formed negative electrode active material was coated on a negative electrode current collector made of a copper foil, dried, compressed using a roll press machine, and then punched out to obtain a negative electrode in a form of pellet having a diameter of 15.5 mm.

Positive electrode: Lithium carbonate and cobalt carbonate were mixed in a molar ratio of 0.5:1, and sintered in the air at 900° C. for 5 hours, to thereby obtain LiCoO₂ as a positive electrode active material. Ninety-one parts by weight of LiCoO₂, 6 parts by weight of graphite as a conductive material, and 3 parts by weight of PVdF as a binder were mixed to thereby prepare a positive electrode mixture, and the positive electrode mixture was further added with NMP as a solvent to thereby obtain a positive electrode active material in a slurry form. The slurry-formed positive electrode active material was coated on a positive electrode current collector made of an aluminum foil, dried, compressed using a roll press machine, and then punched out to obtain a positive electrode in a form of pellet having a diameter of 15.5 mm.

Non-aqueous electrolyte solution: LiPF₆ was dissolved in a 50:50 (v/v) mixed solution of ethylene carbonate and diethyl carbonate so as to adjust the concentration thereof to 1.0 mol/L.

Thus-fabricated negative electrode member and positive electrode member were enclosed in a battery container as being stacked while placing a micro-porous separator made of a polypropylene film of 25 μm thick in between, and the non-aqueous electrolyte was then poured into the battery container to thereby manufacture the coin-type battery.

### Example 1-2

The battery was manufactured under conditions similar to those in Example 1-1, except that the carbon black to be mixed with Cu-Sn powder was such as having a DBP oil absorption of 175 ml/100 g and a specific surface area of 68 m²/g.

### Example 1-3

The battery was manufactured under conditions similar to those in Example 1-1, except that the carbon black to be mixed with Cu-Sn powder was such as having a DBP oil absorption of 220 ml/100 g and a specific surface area of 133 m²/g.

### Example 1-4

The battery was manufactured under conditions similar to those in Example 1-1, except that the carbon black to be mixed with Cu-Sn powder was such as having a DBP oil absorption of 230 ml/100 g and a specific surface area. of 150 m²/g.

In contrast to the above Examples, also Comparative Examples were prepared.

### Comparative Example 1-1

The battery was manufactured under conditions similar to those in Example 1-1, except that the carbon black to be mixed with Cu-Sn powder was such as having a DBP oil absorption of 105 ml/100 g and a specific surface area of 50 m²/g.

### Comparative Example 1-2

The battery was manufactured under conditions similar to those in Example 1-1, except that the carbon black to be mixed with Cu-Sn powder was such as having a DBP oil absorption of 137 ml/100 g and a specific surface area of 25 m²/g.

### Comparative Example 1-3

The battery was manufactured under conditions similar to those in Example 1-1, except that the carbon black to be mixed with Cu-Sn powder was such as having a DBP oil absorption of 250 ml/100 g and a specific surface area of 170 m²/g.

### Comparative Example 1-4

The battery was manufactured under conditions similar to those in Example 1-1, except that the carbon black to be mixed with Cu-Sn powder was such as having a DBP oil absorption of 300 ml/100 g and a specific surface area of 250 m²/g.

### Evaluation

The above-described Examples 1-1 to 1-4 and Comparative Examples 1-1 to 1-4 were individually evaluated according to the methods described below. Each of the lithium ion secondary batteries was charged under a constant current of 1 mA and a constant voltage of maximum 4.2 V at 20° C., and was then discharged under a constant current of 1 mA down to 2.5 V, where a ratio of the amount of discharge to the amount of charge was determined as an efficiency (%). The relative discharge capacity after the 10th cycle was also evaluated by repeating the charge/discharge cycle 10 times under the same conditions, and by calculating a capacity retention ratio (%) of the discharge capacity observed after the 10th cycle assuming the initial discharge capacity as 100. Results were shown in Table 1.

TABLE 11

| | DBP oil | Specific | Capacity | |
|---|---|---|---|---|
| | absorption | surface | retention | Efficiency |
| | (ml/100 g) | area (m²/g) | ratio (%) | (%) |
| Example 1-1 | 150 | 100 | 84 | 89.9 |
| Example 1-2 | 175 | 68 | 87 | 88.3 |
| Example 1-3 | 220 | 133 | 90 | 89.6 |
| Example 1-4 | 230 | 150 | 92 | 89.1 |
| Comparative | 105 | 50 | 47 | 89.6 |
| Example 1-1 | | | | |
| Comparative | 137 | 25 | 70 | 88.7 |
| Example 1-2 | | | | |
| Comparative | 250 | 170 | 92 | 81.4 |
| Example 1-3 | | | | |
| Comparative | 300 | 250 | 93 | 74.7 |
| Example 1-4 | | | | |

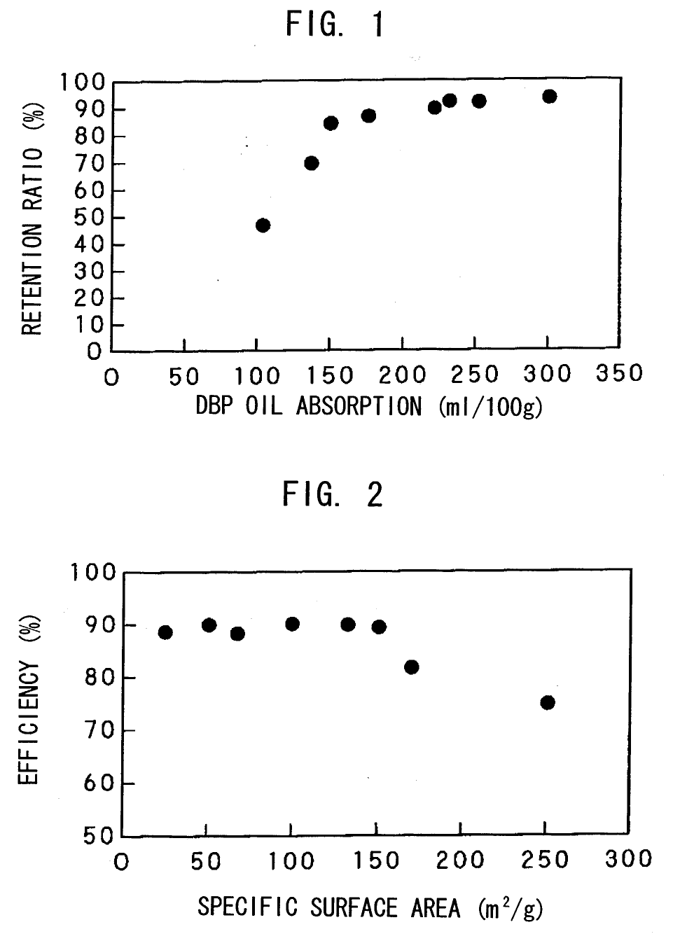

FIG. 1 is a graph in which the results of the above Examples and Comparative Examples were plotted while defining the abscissa as the DBP oil absorption (ml/100 g) of the carbon black, and the ordinate as the relative discharge capacity. FIG. 2 a graph in which the results of the above Examples and Comparative Examples were plotted while defining the abscissa as the specific surface area (m²/g) of the carbon black, and the ordinate as the efficiency.

As is clear from the above evaluation results, the carbon black having a DBP oil absorption of 150 ml/100 g (Example 1-1) resulted in a relative discharge capacity of the lithium ion secondary battery of 84%, but a carbon black having a DBP oil absorption of 105 ml/100 g (Comparative Example 1-2) resulted in a capacity retention ratio considerably lowered to as small as 47%. The carbon black having a DBP oil absorption of less than 150 ml/100 g has only an cushion effect insufficient for suppressing cracks or separation between Cu-Sn grains which tend to expand and shrink during charge and discharge, and this pulverizes the powder to thereby ruin the capacity retention ratio.

The carbon black having a DBP oil absorption of 300 ml/100 g (Comparative Example 1-4) resulted in a desirable capacity retention ratio of the lithium ion battery of 93%, but in an efficiency lowered to as small as 74.7%. The carbon black having a DBP oil absorption exceeding 250 ml/100 g has a degraded dispersibility among the Cu—Sn grains due to excessively-developed structure, and thus resulted in only a degraded conductivity. It was considered that this undesirably lowered the battery characteristics on the negative electrode side of the lithium ion secondary battery, and thus degraded the whole efficiency of the battery.

As judged from the above results, the lithium ion secondary battery according to the present invention exhibits optimum characteristics when the carbon black has a DBP oil absorption within a range from 150 ml/100 g to 250 ml/100 g.

Next, examples of the lithium ion secondary batteries using the carbon black and fibrous graphite mixed in predetermined ratios, and comparative examples of lithium ion secondary batteries using either one of the carbon black and fibrous graphite were manufactured, and individually evaluated.

### Example 2-1

Negative electrode: Fifty parts by weight of copper and 50 parts by weight of tin are melted, and Cu—Sn powder as the negative electrode active material was synthesized by the gas atomizing method. To 53 parts by weight of the Cu—Sn powder, 1 part by weight of acetylene black, 1 part by weight of fibrous graphite, 35 parts by weight of artificial graphite, and 10 parts by weight of PVdF as a binder were mixed to thereby prepare a negative electrode mixture, and the negative electrode mixture was further added with NMP as a solvent to thereby obtain a negative electrode active material in a slurry form. The slurry-formed negative electrode active material was coated on a negative electrode current collector made of a copper foil, dried, compressed using a roll press machine, and then punched out to obtain a negative electrode in a form of pellet having a diameter of 15.5 mm.

Positive electrode: Lithium carbonate and cobalt carbonate were mixed in a molar ratio of 0.5:1, and sintered in the air at 900° C. for 5 hours, to thereby obtain LiCoO₂ as a positive electrode active material. Ninety-one weight parts of LiCoO₂, 6 parts by weight of graphite as a conductive material, and 3 parts by weight of PVdF as a binder were mixed to thereby prepare a positive electrode mixture, and the positive electrode mixture was further added with NMP as a solvent to thereby obtain a positive electrode active material in a slurry form. The slurry-formed positive electrode active material was coated on a positive electrode current collector made of an aluminum foil, dried, compressed using a roll press machine, and then punched out to obtain a positive electrode in a form of pellet having a diameter of 15.5 mm.

Non-aqueous electrolyte solution: LiPF₆ was dissolved in a 50:50 (v/v) mixed solution of ethylene carbonate and diethyl carbonate so as to adjust the concentration thereof to 1.0 mol/L.

Thus-fabricated negative electrode member and positive electrode member were enclosed in a battery container as being stacked while placing a micro-porous separator made of a polypropylene film of 25 μm thick in between, and the non-aqueous electrolyte was then poured into the battery container to thereby manufacture a coin-type battery.

### Example 2-2

The battery was manufactured under conditions similar to those in Example 2-1, except for using the negative electrode mixture prepared by mixing 51 parts by weight of Cu-Sn powder, 2 parts by weight of acetylene black, 2 parts by weight of fibrous graphite, 35 parts by weight of artificial graphite and 10 parts by weight of PVdF as a binder.

### Example 2-3

The battery was manufactured under conditions similar to those in Example 2-1, except for using the negative electrode mixture prepared by mixing 51 parts by weight of Cu-Sn powder, 3 parts by weight of acetylene black, 1 part by weight of fibrous graphite, 35 parts by weight of artificial graphite and 10 parts by weight of PVdF as a binder.

### Example 2-4

The battery was manufactured under conditions similar to those in Example 2-1, except for using the negative electrode mixture prepared by mixing 51 parts by weight of Cu-Sn powder, 1 part by weight of acetylene black, 3 parts by weight of fibrous graphite, 35 parts by weight of artificial graphite and 10 parts by weight of PVdF as a binder.

### Example 2-5

The battery was manufactured under conditions similar to those in Example 2-1, except that Fe-Sn powder was used in place of the Cu-Sn powder.

### Comparative Example 2-1

The battery was manufactured under conditions similar to those in Example 2-1, except for using the negative electrode mixture prepared by mixing 53 parts by weight of Cu-Sn powder, 2 parts by weight of acetylene black, 35 parts by weight of artificial graphite and 10 parts by weight of PVdF as a binder.

### Comparative Example 2-2

The battery was manufactured under conditions similar to those in Example 2-1, except for using the negative electrode mixture prepared by mixing 53 parts by weight of Cu-Sn powder, 2 parts by weight of fibrous graphite, 35 parts by weight of artificial graphite and 10 parts by weight of PVdF as a binder.

### Comparative Example 2-3

The battery was manufactured under conditions similar to those in Example 2-1, except for using the negative electrode mixture prepared by mixing 51 parts by weight of Cu-Sn powder, 4 parts by weight of acetylene black, 35 parts by weight of artificial graphite and 10 parts by weight of PVdF as a binder.

### Comparative Example 2-4

The battery was manufactured under conditions similar to those in Example 2-1, except for using the negative electrode mixture prepared by mixing 51 parts by weight of Cu-Sn powder, 4 parts by weight of fibrous graphite, 35 parts by weight of artificial graphite and 10 parts by weight of PVdF as a binder.

### Evaluation

The above-described Examples 2-1 to 2-5 and Comparative Examples 2-1 to 2-4 were individually evaluated according to the methods described below. Each of the lithium ion secondary batteries was charged under a constant current of 10 mA and a constant voltage of maximum 4.2 V at 20° C., and was then discharged under a constant current of 10 mA down to 2.5 V, where a discharge capacity for the 1st cycle (mAh) was measured. The relative discharge capacity after the 100th cycle was also evaluated by repeating the charge/discharge cycle 100 times under the same conditions, an by calculating a capacity retention ratio (%) of the discharge capacity observed after the 100th cycle assuming the initial discharge capacity as 100. Results were shown in Table 2.

TABLE 2

| | Content | Content | | Capacity |
|---|---|---|---|---|
| | of | of | Discharge | retention |
| | carbon | fibrous | capacity | ratio after |
| | black | graphite | for 1st | 100th cycle |
| | (wt part) | (wt part) | cycle (mAh) | (%) |
| Example 2-1 | 1 | 1 | 14.1 | 85.0 |
| Example 2-2 | 2 | 2 | 13.0 | 87.1 |
| Example 2-3 | 3 | 1 | 13.5 | 86.5 |
| Example 2-4 | 1 | 3 | 13.3 | 87.3 |
| Example 2-5 | 1 | 1 | 13.9 | 85.5 |
| Comparative | 2 | 0 | 12.0 | 77.0 |
| Example 2-1 | | | | |
| Comparative | 0 | 2 | 12.5 | 75.5 |
| Example 2-2 | | | | |
| Comparative | 4 | 0 | 11.0 | 82.1 |
| Example 2-3 | | | | |
| Comparative | 0 | 4 | 11.8 | 81.5 |
| Example 2-4 | | | | |

The lithium ion secondary battery of Example 2-1 showed a discharge capacity for the first cycle of 14.1 mAh and a capacity retention ratio after the 100th cycle of 85.0%. On the contrary, the lithium ion secondary batteries of Comparative Examples 2-1 and 2-2, which contain either one of the carbon black and fibrous graphite in the negative electrode active materials in the contents same as the total content of the carbon black and fibrous graphite for the Example 2-1, showed the discharge capacities for the first cycle of 12.0 mAh and 12.5 mAh, respectively, and the capacity retention ratios after the 100th cycle of 77.0% and 75.5%, respectively.

The lithium ion secondary batteries of Comparative Examples 2-3 and 2-4, which contain either one of the carbon black and fibrous graphite in the contents larger than the total content of the carbon black and fibrous graphite for the lithium ion secondary battery of Example 2-1, showed the discharge capacities for the first cycle of 11.0 mAh and 11.8 mAh, respectively, and the capacity retention ratios after the 100th cycle of 82.10% and 81.5%, respectively.

As judged from the above results, the lithium ion secondary battery according to the present invention is successful in improving the characteristics of discharge capacity and capacity retention ratio through mixed use of carbon black and fibrous graphite for the negative electrode active material.

The lithium ion secondary battery acquires an improved capacity retention ratio as a whole by being added with both of carbon black and fibrous graphite. Further improvement in the capacity retention ratio is ascribable to that the carbon black exerts a cushion effect so as to suppress cracks and separation of the CuSn grains within the negative electrode member, and that the fibrous graphite enhances the bonding strength of the Cu—Sn grains so as to suppress pulverization of the negative electrode active material.

When the contents of the carbon black and fibrous graphite are increased, the lithium ion secondary battery undesirably reduces the discharge capacity thereof due to relative decrease in the amount of negative electrode active material per unit weight. The lithium ion secondary battery is thus preferable to select the total content of the carbon black and fibrous graphite as 10 parts by weight or below, and more preferably 5 parts by weight or around.

What is claimed is:

1. A non-aqueous electrolyte secondary battery comprising:
a negative electrode comprising a negative electrode active material composed of an element or a compound of the element capable of reacting with lithium, and a negative electrode current collector;
a positive electrode comprising a positive electrode active material and a positive electrode current collector;
a non-aqueous electrolyte; and
a container for enclosing said negative electrode, said positive electrode and said non-aqueous electrolyte; wherein:
said negative electrode active material of said negative electrode containing carbon black.

2. The non-aqueous electrolyte secondary battery as claimed in claim 1, wherein said carbon black has a DBP oil absorption of 150 ml/100 g to 250 ml/100 g, and a specific surface area of 50 m²/g to 150 m²/g.

3. The non-aqueous electrolyte secondary battery as claimed in claim 1, wherein said negative electrode active material is a Group 4B compound comprising a Group 4B element other than carbon and at least one nonmetallic element.

4. A non-aqueous electrolyte secondary battery comprising:
a negative electrode comprising a negative electrode active material composed of an element or a compound of the element capable of reacting with lithium, and a negative electrode current collector;
a positive electrode comprising a positive electrode active material and a positive electrode current collector;
a non-aqueous electrolyte; and
a container for enclosing said negative electrode, said positive electrode and said non-aqueous electrolyte; wherein:
said negative electrode active material of said negative electrode containing carbon black and fibrous graphite.

5. The non-aqueous electrolyte secondary battery as claimed in claim 4, wherein said carbon black has a DBP oil absorption of 150 ml/100 g to 250 ml/100 g, and a specific surface area of 50 m²/g to 150 m²/g.

6. The non-aqueous electrolyte secondary battery as claimed in claim 4, wherein said negative electrode active material is a Group 4B compound comprising a Group 4B element other than carbon and at least one nonmetallic element.
